(19) United States
(12) Patent Application Publication
(10) Pub. No.: US 2026/0147831 A1
(43) Pub. Date: May 28, 2026

(54) METHOD AND ELECTRONIC DEVICE FOR LARGE-SCALE VIDEO MANAGEMENT

(71) Applicant: Wistron Corp., New Taipei City (TW)

(72) Inventors: Huai Yi WANG, New Taipei City (TW); Hsien Ta WU, New Taipei City (TW); Yusiang LIN, New Taipei City (TW)

(21) Appl. No.: 19/070,743

(22) Filed: Mar. 5, 2025

(30) Foreign Application Priority Data
Nov. 27, 2024 (TW) 113145652

(51) Int. Cl. G06F 16/735; G06F 16/738; G06V 20/40; G06V 20/52; G11B 27/10; G11B 27/34

(52) U.S. Cl. CPC G06F 16/735; G06F 16/738; G06V 20/44; G06V 20/52; G11B 27/102; G11B 27/34

(57) ABSTRACT

A method for large-scale video management is provided. The method is applicable to a surveillance system. The method includes the following steps. Large-scale videos are tagged in response to an event being detected. The large-scale videos are associated in response to the large-scale videos that have been tagged. The disclosed method uses attribute tag indexing technology that is closest to human search logic to effectively manage the large-scale videos and automatically search for relevant video results based on input information, greatly simplifying the search process and improving user experience.

### CROSS REFERENCE TO RELATED APPLICATIONS

This Application claims the benefit of Taiwan Application No. 113145652, filed on Nov. 27, 2024, the entirety of which are incorporated by reference herein.

### BACKGROUND OF THE INVENTION

### Field of the Invention

The present disclosure relates to a method for video data management, and, in particular, it relates to a method and an electronic device for large-scale video management.

### Description of the Related Art

Surveillance cameras are currently used widely in places where humans live. In the field of surveillance, usually for the purpose of complete evidence preservation, the number of videos that need to be preserved is also very large. Therefore, when the number of stored videos continues to grow, users need to manage countless videos. This kind of management method will also prevent the video layout display from showing the desired videos, making it difficult to find important videos and resulting in a poor user experience.

Most video surveillance or video playback systems on the market usually have certain insurmountable shortcomings. First, fixed video list is restricted used or an N*N selectable format for layout is displayed. Second, the traditional video management method can only filter by time and camera number, at best. Third, even if there are very few smart cameras used, they only use simple object detection events to filter the video list. None of the existing solutions mentioned above can effectively solve the difficulties associated with reviewing and finding a large number of videos.

### BRIEF SUMMARY OF THE INVENTION

An embodiment of the present disclosure provides a method for large-scale video management. The method is applicable to a surveillance system. The method includes the following steps. Large-scale videos are tagged in response to an event being detected. The large-scale videos are associated in response to the large-scale videos that have been tagged. The disclosed method uses attribute tag indexing technology that is closest to human search logic to effectively manage the large-scale videos and automatically search for relevant video results based on input information, greatly simplifying the search process and improving user experience.

An embodiment of the present disclosure provides an electronic device. The electronic device includes a display and a processor. The display has a resolution. The processor tags large-scale videos in response to an event being detected, and associates the large-scale videos in response to the large-scale videos that have been tagged.

### BRIEF DESCRIPTION OF THE DRAWINGS

The present disclosure can be more fully understood by reading the subsequent detailed description and examples with references made to the accompanying drawings, wherein:

FIG. 1A and FIG. 1B show flow charts of a method for large-scale video management in accordance with some embodiments of the present invention;

FIG. 2 shows a detail flow chart of the method for large-scale video management in accordance with some embodiments of the present invention;

FIG. 3 shows a detail flow chart of the method for large-scale video management in accordance with some embodiments of the present invention;

FIG. 4 shows a schematic diagram of a surveillance system 400 in accordance with some embodiments of the present invention;

FIGS. 5A to 5I shows a schematic diagram of a user interface 426 in FIG. 4 displaying 1 to 9 videos in accordance with some embodiments of the present invention;

FIG. 6A shows a schematic diagram of the user interface 426 in FIG. 4 displaying a video-time correlation map in accordance with some embodiments of the present invention;

FIG. 6B shows a schematic diagram of the user interface 426 in FIG. 4 displaying a video-position correlation map in accordance with some embodiments of the present invention;

FIG. 7A shows a schematic diagram of the user interface 426 in FIG. 4 displaying a default recommendation list and a search field object in accordance with some embodiments of the present invention;

FIG. 7B shows a schematic diagram of the user interface 426 in FIG. 4 displaying the default recommendation list and clicking a target video in accordance with some embodiments of the present invention;

FIG. 8 shows a detail flow chart of an adaptive video playback in the method for large-scale videos management FIG. 1B in accordance with some embodiments of the present invention.

### DETAILED DESCRIPTION OF THE INVENTION

In order to make the above purposes, features, and advantages of some embodiments of the present disclosure more comprehensible, the following is a detailed description in conjunction with the accompanying drawing.

Certain terms are used throughout the description and following claims to refer to particular components. As one skilled in the art will understand, electronic equipment manufacturers may refer to a component by different names. This document does not intend to distinguish between components that differ in name but not function. It is understood that the words “comprise”, “have” and “include” are used in an open-ended fashion, and thus should be interpreted to mean “include, but not limited to . . . ”. Thus, when the terms “comprise”, “have” or “include” used in the present disclosure are used to indicate the existence of specific technical features, values, method steps, operations, units or components. However, it does not exclude the possibility that more technical features, numerical values, method steps, work processes, units, components, or any combination of the above can be added.

The directional terms used throughout the description and following claims, such as: “on”, “up”, “front”, “left”, etc., are only directions referring to the drawings. Therefore, the directional terms are used for explaining and not used for limiting the present invention. Regarding the drawings, the drawings show the general characteristics of methods, structures, or materials used in specific embodiments. However, the drawings should not be construed as defining or limiting the scope or properties encompassed by these embodiments. For example, for clarity, the relative size, thickness, and position of each layer, each area, or each structure may be reduced or enlarged.

When the corresponding component such as layer or area is referred to as being “on another component”, it may be directly on this other component, or other components may exist between them. On the other hand, when the component is referred to as being “directly on another component (or the variant thereof)”, there is no component between them. Furthermore, when the corresponding component is referred to as being “on another component”, the corresponding component and the other component have a disposition relationship along a top-view/vertical direction, the corresponding component may be below or above the other component, and the disposition relationship along the top-view/vertical direction is determined by the orientation of the device.

It should be understood that when a component or layer is referred to as being “connected to” another component or layer, it can be directly connected to this other component or layer, or intervening components or layers may be present. In contrast, when a component is referred to as being “directly connected to” another component or layer, there are no intervening components or layers present.

The electrical connection or coupling described in this disclosure may refer to direct connection or indirect connection. In the case of direct connection, the endpoints of the components on the two circuits are directly connected or connected to each other by a conductor line segment, while in the case of indirect connection, there are switches, diodes, capacitors, inductors, resistors, other suitable components, or a combination of the above components between the endpoints of the components on the two circuits, but the intermediate component is not limited thereto.

The words “first”, “second”, and “third” are used to describe components. They are not used to indicate the priority order of or advance relationship, but only to distinguish components with the same name.

It should be noted that the technical features in different embodiments described in the following can be replaced, recombined, or mixed with one another to constitute another embodiment without depart in from the spirit of the present invention.

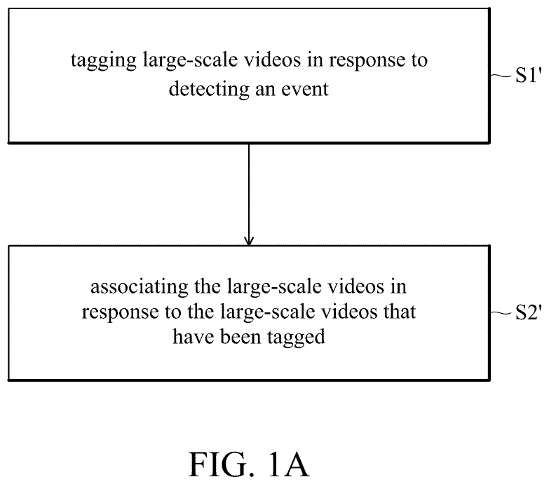

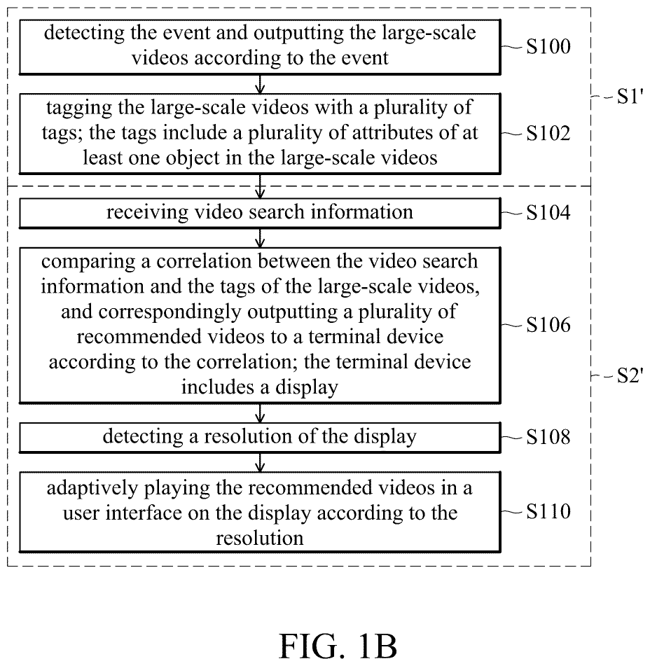

FIG. 1A and FIG. 1B show flow charts of a method for large-scale video management in accordance with some embodiments of the present invention. The method for large-scale video management of the present disclosure is applicable to a surveillance system, but the present disclosure is not limited thereto. In some embodiments, the surveillance system includes smart cameras, back-end servers, databases, and terminal devices, but the present disclosure is not limited thereto. As shown in FIG. 1A, the method for large-scale video management of the present disclosure includes the following steps. Large-scale videos are tagged in response to an event being detected (step S1′). The large-scale videos are associated in response to the large-scale videos that have been tagged (step S2′). In some embodiments, the large-scale videos may include, for example, thousands to tens of thousands of frames of videos, but the present disclosure is not limited thereto. In some embodiments, as shown in FIG. 1B, step S1′ includes the following steps. The event is detected and the large-scale videos are output according to the event (step S100). The large-scale videos are tagged with a plurality of tags. The tags include a plurality of attributes of at least one object in the large-scale videos (step S102). In some embodiments, step S2′ includes the following steps. Video search information is received (step S104). A correlation between the video search information and the tags of the large-scale videos is compared, and a plurality of recommended videos are output to a terminal device according to the correlation. The terminal device comprises a display (step S106). The resolution of the display is detected (step S108). The recommended videos are adaptively played in a user interface on the display according to the resolution (step S110).

In some embodiments of step S100, the detected event may be, for example, that the smart camera captures an object (such as a person or a car) entering its shooting range, so the smart camera correspondingly outputs large-scale videos including the object. In some embodiments of step S102, the smart cameras perform an object detection on the at least one object in the large-scale videos to obtain position information of the at least one object. For example, the smart cameras execute a target detection algorithm and cut out the target object according to its coordinates position. Then, the smart cameras perform a multi-attribute recognition on the at least one object in the large-scale videos to obtain a main attribute of the at least one object, and to obtain a plurality of subordinate attributes of the at least one object according to the main attribute. In some embodiments, the main attribute can be, for example, a target category, such as a person or a car, but the present disclosure is not limited thereto. If the main attribute of at least one object is a person, the subordinate attributes of at least one object may be, for example, gender, age, clothing, body accessories, hair length, etc., but the present disclosure is not limited thereto. After that, the smart cameras generate the tags of the large-scale videos according to the main attribute and the subordinate attributes. In some embodiments, in addition to the main attributes and subordinate attributes of at least one object, the tags also include external states such as the monitor's model, time, location, etc.

In some embodiments of step S104, the present disclosure receives video search information through a user interface on the display of the terminal device. In some embodiments, the terminal device can be, for example, a desktop, a notebook, a tablet, a smart phone, etc. In some embodiments, the video search information may be, for example, text or image. A backend server generates multiple search attribute tags based on the video search information. In some embodiments of step S106, the backend server compares a correlation of the tags of the videos recorded in the video search information (for example, search attribute tags), and outputs recommended videos to the terminal device based on the correlation. In some embodiments, the backend server selects N videos among the large-scale videos that have the highest overlap between the tags and the video search information, sets the N videos as the recommended videos, and outputs the N videos to the terminal device.

In some embodiments of step S108, the terminal device executes an application to detect the resolution of the display. In some embodiments, before detecting the resolution, the terminal device first detects changes in the number of the recommended videos (for example, it changes to N videos). In some embodiments of step S110, the terminal device executes the application to adaptively play the recommended videos in the user interface on the display according to the resolution. In detail, after detecting the resolution, the terminal device further obtains the maximum field number when the recommended videos are displayed in the user interface. Next, the terminal device determines a current field number based on the number of recommended videos and the maximum field number. The terminal device determines the number of at least one special adaptive video included in the recommended videos. The terminal device calculates the width percentage of said special adaptive video, and calculates the width percentage of a plurality of generic adaptive videos included in the recommended videos. In some embodiments, the special adaptive videos are videos that require special calculations to get the width percentage. The generic adaptive videos are not special adaptive videos.

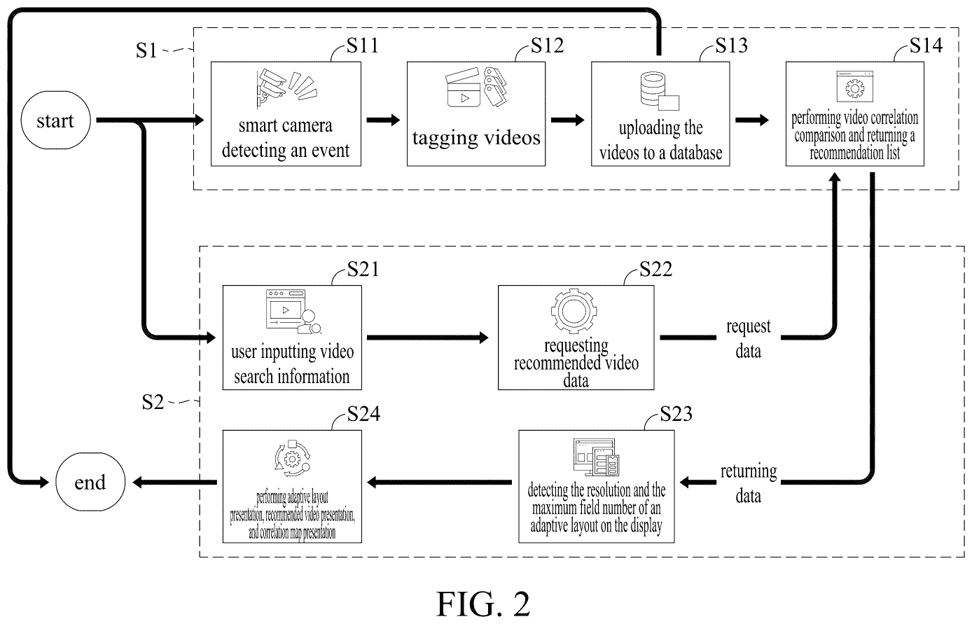

FIG. 2 shows a detail flow chart of the method for large-scale video management in accordance with some embodiments of the present invention. As shown in FIG. 2, the method for large-scale video management of the present disclosure may separately execute a tag generation process S1 and an adaptive video interface display process S2. In the tag generation process S1, the smart camera detects an event (step S11) and outputs a plurality of videos accordingly. Then, the method for large-scale video management of the present disclosure tags the videos (step S12) and uploads the videos to a database (step S13). After that, the method for large-scale video management of the present disclosure performs video correlation comparison and returns a recommendation list (step S14). The recommendation list may include, for example, N recommended videos. The tag generation process S1 can effectively reduce the time required for users to perform multiple manual filters and use full manual identification to find target videos, reduces operational complexity to improve video search efficiency, and then establishes a video correlation map as an advanced video preview list.

In the adaptive video interface display process S2, a user inputs video search information (step S21). For example, the user enters the video search information through the user interface on the display of the terminal device. After receiving the video search information entered by the user, the method for large-scale video management of the present disclosure sends request data for the recommended video from a back-end server (step S22). After the back-end server receives the request data, the method for large-scale video management of the present disclosure returns the recommended video data to the terminal device. Then, the method for large-scale video management of the present disclosure detects the resolution of the display and obtains the maximum field number of an adaptive layout on the display (step S23). The method for large-scale video management of the present disclosure performs adaptive layout presentation, recommended video presentation, and correlation map presentation (step S24). The adaptive video interface display process S2 is designed to reduce the waste of operating interface layout space and provide solutions to the difficulty of playing a large number of videos. At the same time, users can choose whether to display the returned video results in a video correlation map according to their own needs. The video correlation map will present the search results in a more structured manner based on the tag information of the video itself, so that the users can understand the correlation information between videos. Finally, based on structured sorting results, the management method for large-scale video management of the present disclosure will play the videos in order on the adaptive layout, so as to achieve a simplified search process that allows the user to browse a large number of correlation videos with a single input to optimize the user experience.

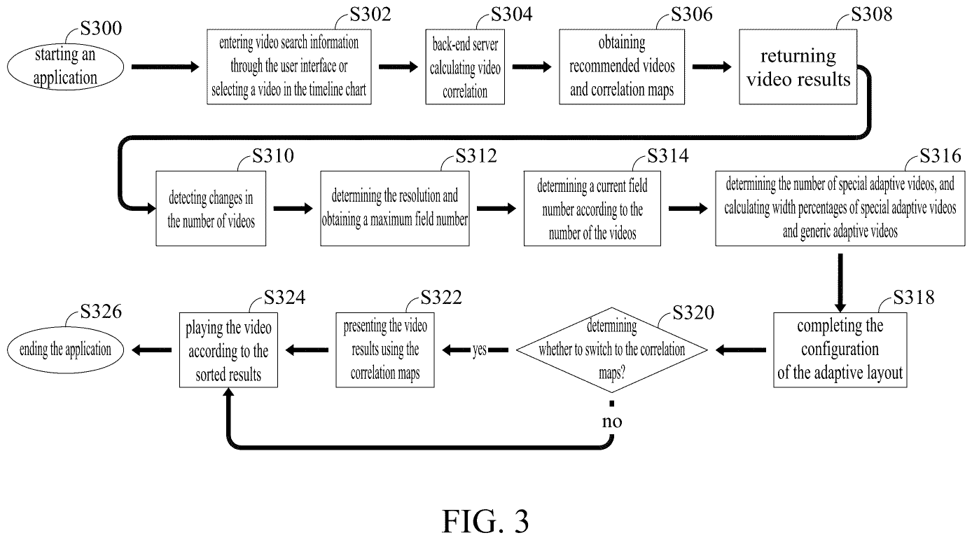

FIG. 3 shows a detail flow chart of the method for large-scale video management in accordance with some embodiments of the present invention. As shown in FIG. 3, the terminal device starts an application (step S300) to present a user interface on its display. The user enters video search information through the user interface or selects a video in the timeline chart (step S302). In step S302, the method for large-scale video management of the present disclosure performs image sorting by user inputting search information for videos containing text or images, or using attribute tags converted from videos selected in the timeline chart. Then, the back-end server uses the attribute tags converted from the video content to compare the correlation of the attributes in the video search information and the tags of the video, that is, the back-end server calculates a correlation of the videos (step S304). The back-end server obtains the recommended videos and the correlation maps according to the correlation (step S306), and outputs the recommended videos and the correlation maps correspondingly, that is, returns the video results to the terminal device (step S308). In some embodiments, step S302, step S304, step S306, and step S308 are recommendation system processes.

Then, the terminal device detects changes in the number of recommended videos (step S310). The terminal device detects or determines the resolution of the display, and obtains the maximum field number (step S312). The terminal device determines a current field number according to the number of recommended videos and the maximum field number (step S314). After that, the terminal device determines the number of special adaptive videos, and calculates a width percentage of special adaptive videos and a width percentage of generic adaptive videos (step S316). In step S318, the terminal device completes the configuration of the adaptive layout. Then, in step S320, the terminal device determines whether to switch to the correlation maps. In detail, the user interface includes a first object, a second object, and a third object. The first object outputs an activation message associated with a default recommendation list of the recommended videos. The user interface displays the default recommendation list in response to the first object being clicked. The second object outputs the activation message of a video-time correlation map associated with the recommended videos. The user interface displays the video-time correlation map in response to the second object being clicked. The third object outputs the activation message of a video-position correlation map associated with the recommended videos. The user interface displays the video-position correlation map in response to the third object being clicked.

In other words, in step S320, when the terminal device receives the activation message of the video-time correlation map or the video-position correlation map, the answer in step S320 is “yes”, the terminal device continues to execute step S322. When the terminal device receives the activation message of the default recommendation list, the answer of step S320 is “no”, the terminal device continues to execute step S324. In step S322, the terminal device presents the video results using a correlation map through the user interface. In step S324, the terminal device plays the video according to the sorted results through the user interface. Finally, the terminal device ends the application (step S326). In some embodiments, step S312, step S314, step S316, step S318, step S320, step S322, and step S324 are adaptive video interface display processes.

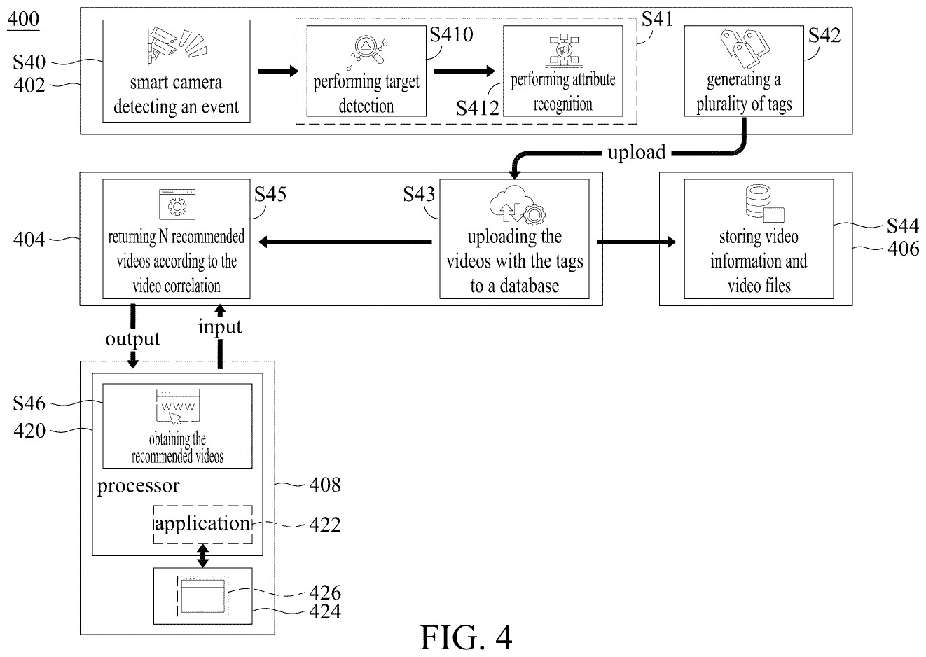

FIG. 4 shows a schematic diagram of a surveillance system 400 in accordance with some embodiments of the present invention. As shown in FIG. 4, the surveillance system 400 includes a smart camera 402, a back-end server 404, a database 406, and a terminal device 408. The back-end server 404 is electrically coupled between the smart camera 402 and the terminal device 408. The back-end server 404 is electrically coupled the database 406. First, the smart camera 402 detects an event (step S40), and outputs a plurality of videos accordingly. Next, the smart camera 402 execute step S41 including performing target detection (step S410) and attribute recognition (step S412) on the videos, so that the smart camera 402 is able to generate a plurality of tags corresponding to the video in step S42. The smart camera 402 uploads the videos with the tags to the back-end server 404. Then, the back-end server 404 uploads the videos with the tags to the database 406 (step S43), so that the database 406 stores video information and video files (step S44). In some embodiments, the database 406 may be, for example, a cloud database, but the present disclosure is not limited thereto.

The back-end server 404 returns N recommended videos to the terminal device 408 according to video correlation, for example, the video search information and the correlation of the tags for the videos (step S45). In some embodiments, the video search information is from the terminal device 408. The terminal device 408 includes a processor 420 and a display 424. For example, the user inputs the video search information through the user interface 426 in the display 424, so that the processor 420 can transmit the video search information to the back-end server 404. In some embodiments, the processor 420 executes an application 422 to display the user interface 426 on the display 424. The user interface 426 includes a search field object to allow the user to enter video search information. The terminal device 408 obtains the recommended videos from the back-end server 404 (step S46). After receiving the recommended videos, the terminal device 408 then detects the resolution of the display 424 and executes the application 422 to adaptively play the recommended video in the user interface 426 on the display 424 according to the resolution.

For example, the processor 420 executes the application 422 to execute the adaptive video interface display process S2 in FIG. 2, and executes steps S312, S314, S316, S318, S320, and S322 in FIG. 3. In some embodiments, the user interface 426 includes the first object, the second object, and the third object. The first object outputs an activation message associated with a default recommendation list of the recommended videos. When the first object is clicked, the user interface displays the default recommendation list. The processor 420 sequentially plays the videos in the default recommendation list according to the correlation between the video search information and the tags of the videos.

In some embodiments, the processor 420 receives the activation message of the correlation map through the user interface 426, and displays the video based on at least one attribute in the video (such as the time or location of the video) in the user interface 426 according to the activation message. Continuing from the previous paragraph, the second object outputs the activation message of the video-time correlation map associated with the recommended video. When the second object is clicked, the user interface 426 displays the video-time correlation map. The third object outputs the activation message of the video-position correlation map associated with the recommended video. When the third object is clicked, the user interface 426 displays a video-position correlation map.

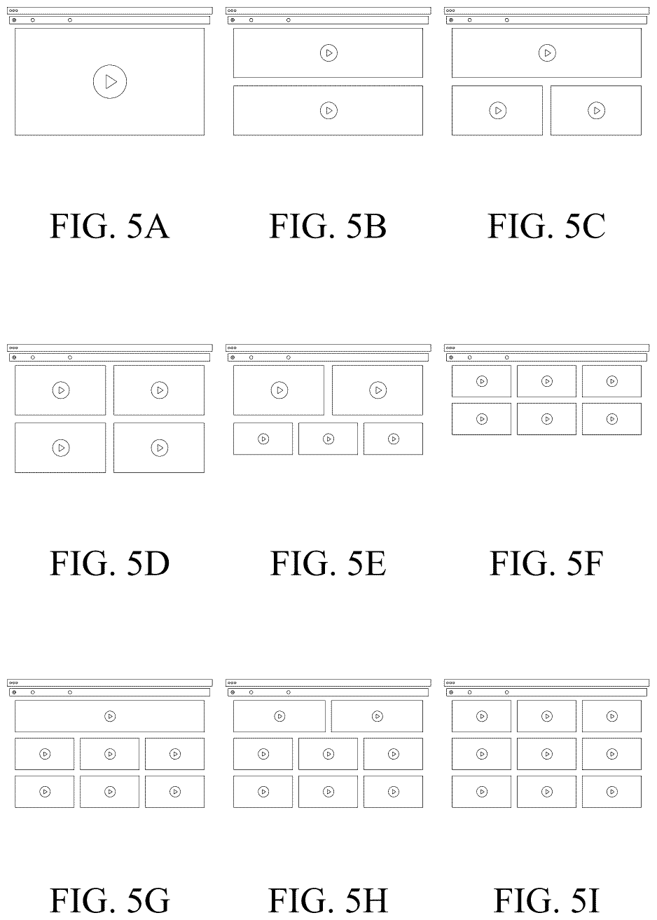

FIGS. 5A to 5I shows a schematic diagram of a user interface 426 in FIG. 4 displaying 1 to 9 videos in accordance with some embodiments of the present invention. As shown in FIG. 5A, the user interface 426 displays 1 video in 1 field and 1 row. As shown in FIG. 5B, the user interface 426 displays 2 videos in 1 field and 2 rows. As shown in FIG. 5C, the user interface 426 displays 3 videos in 2 fields and 2 rows, the video with highest correlation occupies 2 fields of space, and each of the remaining 2 videos occupy 1 field of space. As shown in FIG. 5D, the user interface 426 displays 4 videos in 2 fields and 2 rows. As shown in FIG. 5E, the user interface 426 displays 5 videos in 3 fields and 2 rows, the 2 videos with highest correlation occupies 3 fields of space, and each of the remaining 3 videos occupy 1 field of space. As shown in FIG. 5F, the user interface 426 displays 6 videos in 3 fields and 2 rows.

As shown in FIG. 5G, the user interface 426 displays 7 videos in 3 fields and 3 rows, the 1 video with highest correlation occupies 3 fields of space, and each of the remaining 6 videos occupy 1 field of space. As shown in FIG. 5H, the user interface 426 displays 8 videos in 3 fields and 3 rows, the 2 videos with highest correlation occupies 3 fields of space, and each of the remaining 6 videos occupy 1 field of space. As shown in FIG. 5I, the user interface 426 displays 9 videos in 3 fields and 3 rows.

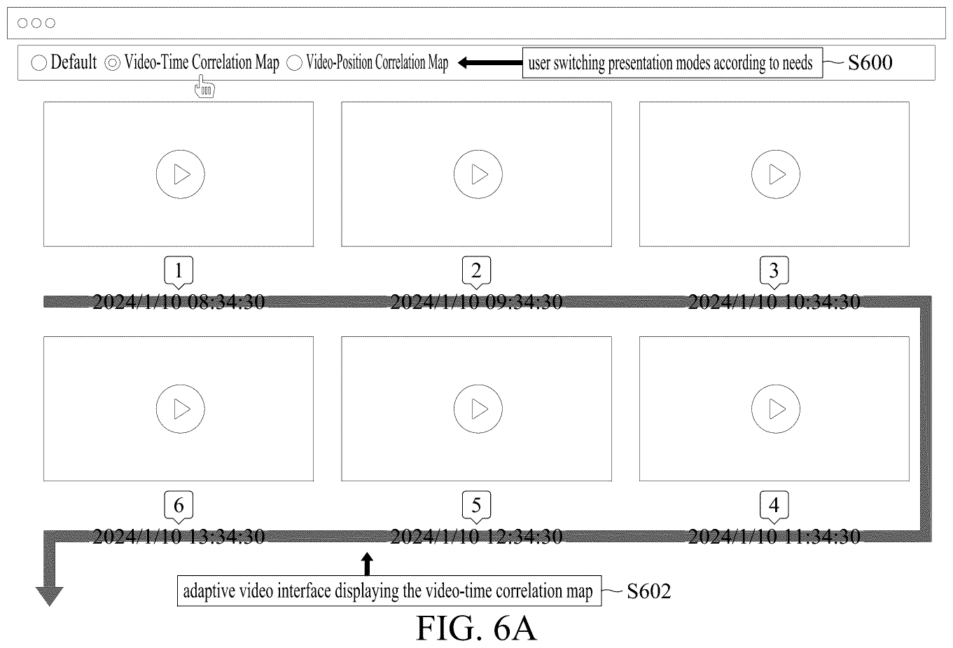

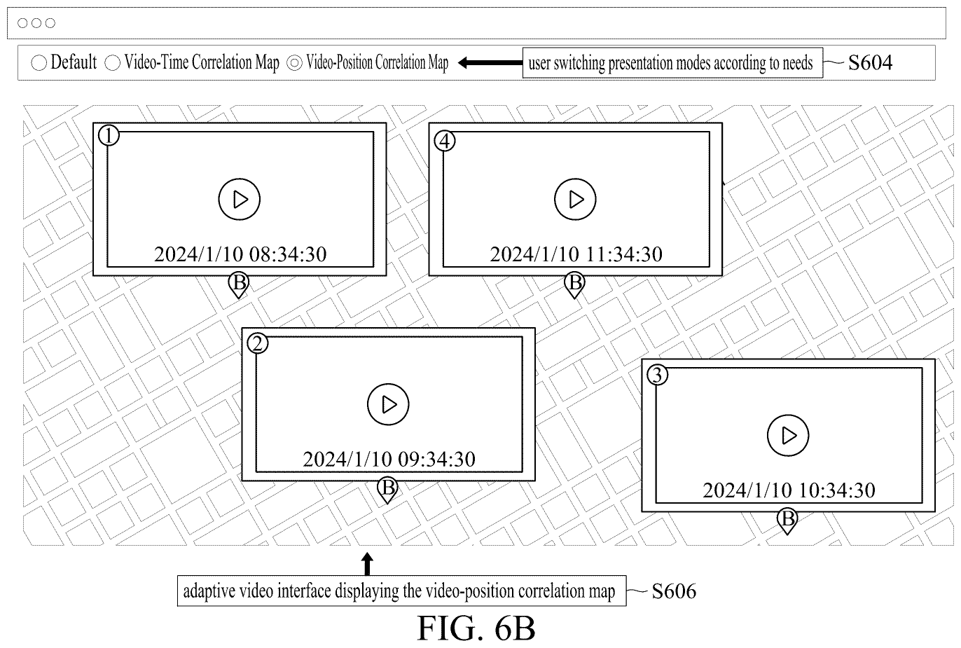

FIG. 6A shows a schematic diagram of the user interface 426 in FIG. 4 displaying a video-time correlation map in accordance with some embodiments of the present invention. As shown in FIG. 6A, the upper left corner of the user interface 426 includes the object “Default”, the object “Video-Time Correlation Map”, and the object “Video-Position Correlation Map”. In step S600, the user switches presentation modes according to needs. For example, when the object “Default” is clicked, the user interface 426 displays the default recommendation list. The processor 420 sequentially plays the videos in the default recommendation list according to the correlation between the video search information and the tags of the videos. In some embodiments of FIG. 6A, when the user clicks the object “Video-Time Correlation Map”, the user interface 426 displays the video-time correlation map. For example, the user interface 426 sequentially sorts videos 1 to 6 as video 1, video 2, video 3, video 4, video, and video 6 according to the time attributes (for example, 2024 Jan. 10 XX:XX:XX). That is, when the user clicks the object “Video-Time Correlation Map”, the processor 420 instructs the user interface 426 to execute step S602, that is, the adaptive video interface displays the video-time correlation map.

FIG. 6B shows a schematic diagram of the user interface 426 in FIG. 4 displaying a video-position correlation map in accordance with some embodiments of the present invention. In step S604, the user switches presentation modes according to needs. For example, in some embodiments of FIG. 6B, when the user clicks the object “Video-Position Correlation Map”, the user interface 426 displays the video-position correlation map. For example, the user interface 426 sets the display position of the videos 1 to 4 in the user interface 426 according to the position attributes of the videos 1 to 4 (for example, B), and plays the videos 1 to 4 in sequence according to the time attributes of the videos 1 to 4. That is, when the user clicks the object “Video-Position Correlation Map”, the processor 420 instructs the user interface 426 to execute step S606, that is, the adaptive video interface displays the video-position correlation map.

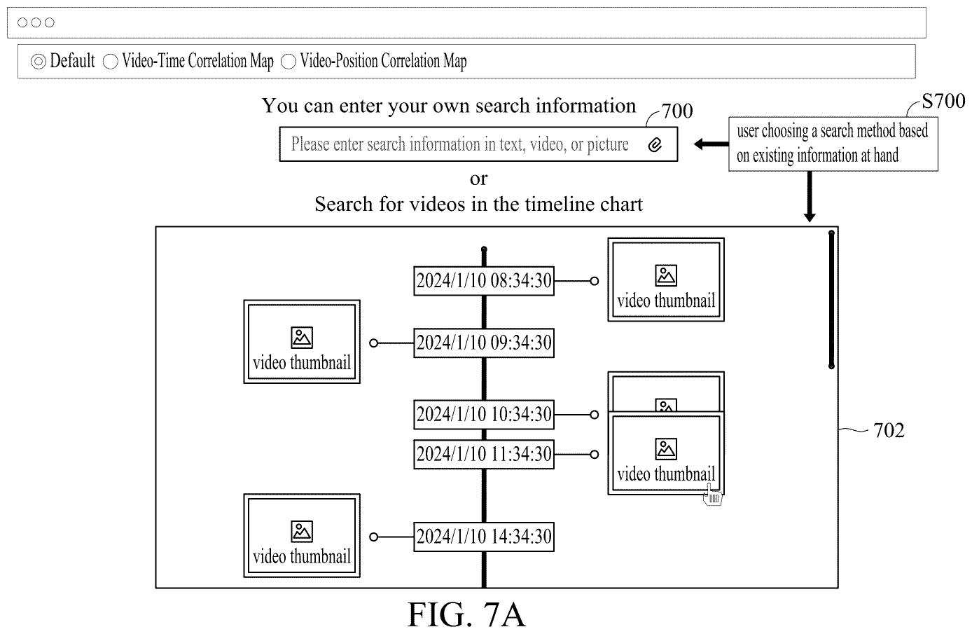

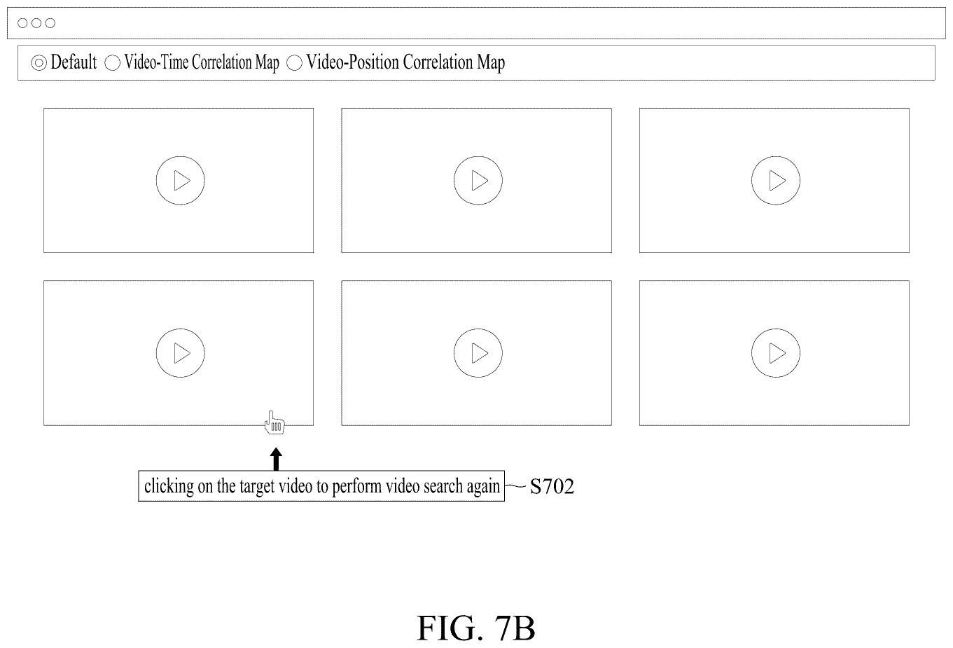

FIG. 7A shows a schematic diagram of the user interface 426 in FIG. 4 displaying a default recommendation list and a search field object in accordance with some embodiments of the present invention. When the object “Default” is clicked, the user interface 426 displays the default recommendation list. In some embodiments of FIG. 7A, the default recommendation list may be presented in the form of a timeline chart 702, for example. The middle portion of the user interface 426 includes a search field object 700. The user can choose a search method based on the existing information at hand (step S700), such as searching with the search field object 700 or searching with the timeline chart 702. If searching using the search field object 700, the user enters video search information in search field object 700. If searching using the timeline chart 702, the user only needs to click on the video thumbnail of a target video to search for the target video.

FIG. 7B shows a schematic diagram of the user interface 426 in FIG. 4 displaying the default recommendation list and clicking a target video in accordance with some embodiments of the present invention. When the object “Default” is clicked, the user interface 426 displays the default recommendation list. The default recommendation list includes the target video. If the user wants to search for the target video, the user clicks on the target video to perform video search again (step S702). After that, the processor 420 sets the target video as updated video search information and sends the updated video search information to the back-end server 404. The back-end server 404 compares a second correlation between the updated video search information and the tags of the videos, and outputs a plurality of second recommended videos to the terminal device 408 according to the second correlation to complete the second search.

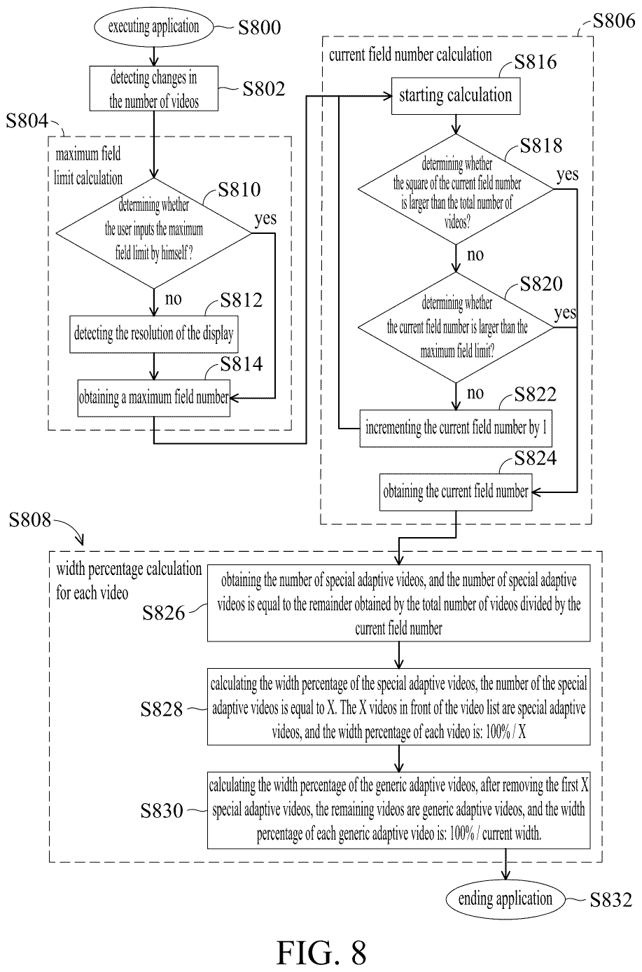

FIG. 8 shows a detail flow chart of an adaptive video playback in the method for large-scale videos management FIG. 1B in accordance with some embodiments of the present invention. As shown in FIG. 8, in step S800, the processor executes the application 422. In step S800, the processor 420 detects changes in the number of recommended videos. Then, the processor 420 executes step S804, that is, calculating the maximum field limit. In detail, the processor 420 determines whether the user inputs the maximum field limit by himself (step S810). If the answer of step S810 is “no”, the processor 420 then detects the resolution of the display 424 (step S812), and obtains the maximum field number (step S814). If the answer of step S810 is “yes”, the processor 420 directly executes step S814.

The processor 420 then executes step S806, that is, the current field number calculation. In detail, the processor 420 starts calculating the current field number in step S816. The processor 420 determines whether the square of the current field number is larger than the total number of videos in step S818. If the answer of step S818 is “yes”, the processor 420 obtains the current field number (step S824). If the answer of step S818 is “no”, the processor 420 continues to determine whether the current field number is larger than the maximum field limit (step S820). If the answer of step S820 is “yes”, the processor 420 obtains the current field number (step S824). If the answer of step S820 is “no”, the processor 420 increments the current field number by 1 (step S822), and returns to step S816. Next, the processor 420 executes a width percentage calculation for each video (step S808).

In detail, in step S826, the processor 420 obtains the number of special adaptive videos, and the number of special adaptive videos is equal to the remainder obtained by the total number of videos divided by the current field number. In some embodiments, the special adaptive videos are videos that require special calculations to get the width percentage. In step S828, the processor 420 calculates the width percentage of the special adaptive videos. For example, the number of special adaptive videos is equal to X. The X videos in front of the video list are special adaptive videos, and the width percentage of each video is: 100%/X. After that, the processor 420 calculates the width percentage of the generic adaptive videos. For example, after the processor 420 removes the first X special adaptive videos, the remaining videos are generic adaptive videos, and the width percentage of each generic adaptive video is: 100%/current width. Finally, the processor 420 ends the application (step S832). In some embodiments, the generic adaptive videos are videos with a width percentage obtained by dividing 100% by the field number.

The present disclosure further discloses a computer program product that executes on the smart camera 402, the back-end server 404, and the terminal device 408. The back-end server 404 is electrically coupled between the smart camera 402 and the terminal device 408. The computer program product includes an event triggering module, a video annotation module, an input module, an attribute comparison module, an output module, a detection module, and an adaptive display module. The event triggering module enables a processor (not shown) of the smart camera 402 to detect an event and output the large-scale videos according to the event. The video annotation module enables the processor of the smart camera 402 to tag the large-scale videos with a plurality of tags. The tags include a plurality of attributes of at least one object in the large-scale videos. The input module enables a processor (not shown) of the back-end server 404 to receive video search information from the terminal device 408. The attribute comparison module enables the processor of the back-end server 404 to compare a correlation between the video search information and the tags of the large-scale videos. The output module enables the processor of the back-end server 404 to correspondingly output a plurality of recommended videos to the terminal device 408 according to the correlation. The terminal device 408 includes the display 424. The adaptive display module enables the processor 420 of the terminal device 408 to adaptively play the recommended videos in the user interface 426 on the display 424 according to the resolution.

In some embodiments, the video annotation module includes include a target detection module, an attribute recognition module, and a tag generation module. The target detection module enables the processor of the smart camera 402 to perform an object detection on the at least one object in the large-scale videos to obtain position information of the at least one object. The attribute recognition module enables the processor of the smart camera 402 to perform a multi-attribute recognition on the at least one object in the large-scale videos to obtain a main attribute of the at least one object, and to obtain a plurality of subordinate attributes of the at least one object according to the main attribute. The tag generation module enables the processor of the smart camera 402 to generate the tags of the large-scale videos according to the main attribute and the subordinate attributes.

In some embodiments, the output module includes a selection module and a setting output module. The selection module enables the processor of the back-end server 404 to select N videos among the large-scale videos that have the highest overlap between the tags and the video search information. The setting output module enables the processor of the back-end server 404 to set the N videos as the recommended videos and output the N videos to the terminal device 408. The method, electronic device and computer program product of the present disclosure use attribute tag indexing technology that is closest to human search logic to solve the problem of excessive misjudgment rates in object feature comparisons. The method, electronic device and computer program product of the present disclosure effectively manages videos and solves the pain points existing in large-scale video systems. The method, electronic device and computer program product of the present disclosure automatically searches for correlation video results based on input information, greatly simplifying the search process and improving user experience.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for large-scale video management, applicable to a surveillance system, comprising:
tagging large-scale videos in response to an event being detected, and
associating the large-scale videos in response to the large-scale videos that have been tagged.

2. The method as claimed in claim 1, wherein the step of tagging the large-scale videos in response to detecting the event comprises:
detecting the event and outputting the large-scale videos according to the event; and
tagging the large-scale videos with a plurality of tags; wherein the tags comprise a plurality of attributes of at least one object in the large-scale videos.

3. The method as claimed in claim 2, wherein the step of associating the large-scale videos in response to the large-scale videos that have been tagged comprises:
receive video search information;
comparing a correlation between the video search information and the tags of the large-scale videos, and correspondingly outputting a plurality of recommended videos to a terminal device according to the correlation;
wherein the terminal device comprises a display;
detecting a resolution of the display; and
adaptively playing the recommended videos in a user interface on the display according to the resolution.

4. The method as claimed in claim 2, wherein the step of tagging the large-scale videos with the tags comprises:
performing an object detection on the at least one object in the large-scale videos to obtain position information of the at least one object;
performing a multi-attribute recognition on the at least one object in the large-scale videos to obtain a main attribute of the at least one object, and to obtain a plurality of subordinate attributes of the at least one object according to the main attribute; and
generating the tags of the large-scale videos according to the main attribute and the subordinate attributes.

5. The method as claimed in claim 3, further comprising:
receiving an activation message for a correlation map through the user interface; and
displaying the large-scale videos in the user interface based on at least one of the attributes in the large-scale videos according to the activation message.

6. The method as claimed in claim 3, further comprising:
playing the large-scale videos in sequence according to the correlation between the video search information and the tags of the large-scale videos.

7. The method as claimed in claim 5, wherein the user interface comprises:
a first object, configured to output an activation message associated with a default recommendation list of the recommended videos; wherein the user interface displays the default recommendation list in response to the first object being clicked;
a second object, configured to output the activation message of a video-time correlation map associated with the recommended videos; the user interface displays the video-time correlation map in response to the second object being clicked; and
a third object, configured to output the activation message of a video-position correlation map associated with the recommended videos; the user interface displays the video-position correlation map in response to the third object being clicked.

8. The method as claimed in claim 3, further comprising:
detecting changes in the number of recommended videos;
obtaining a maximum field number when the recommended videos are displayed in the user interface;
determining a current field number according to the number of recommended videos and the maximum field number;
determining the number of at least one special adaptive video comprised in the recommended videos;
calculating a width percentage of the at least one special adaptive video; and
calculating a width percentage of a plurality of generic adaptive videos comprised in the recommended videos.

9. The method as claimed in claim 5, further comprising:
comparing the correlation between the video search information and the attributes in the tags of the large-scale videos, and outputting the correlation map based on the correlation.

10. The method as claimed in claim 7, wherein the user interface comprises:
a search field object, configured to allow users to enter the video search information.

11. The method as claimed in claim 3, wherein the step of correspondingly outputting the recommended videos to the terminal device according to the correlation comprises:
selecting N videos among the large-scale videos that have the highest overlap between the tags and the video search information; and
setting the N videos as the recommended videos and outputting the N videos to the terminal device.

12. The method as claimed in claim 3, further comprising:
uploading the large-scale videos marked with the tags into a database.

13. The method as claimed in claim 10, further comprising:
setting a target video as updated video search information in response to the target video in the default recommendation list in the user interface, or the video-time correlation map, or the video-position correlation map being clicked;
comparing a second correlation between the updated video search information and the tags of the large-scale videos; and
outputting a plurality of second recommended videos according to the second correlation.

14. An electronic device, comprising:
a display, having a resolution, and a processor, configured to tag large-scale videos in response to an event being detected, and associate the large-scale videos in response to the large-scale videos that have been tagged.

15. The electronic device as claimed in claim 14, wherein the processor receives a plurality of recommended videos, detects the resolution of the display, executes a program to display a user interface on the display, and adaptively plays the recommended videos in the user interface on the display according to the resolution;
wherein the processor receives video search information through the user interface;
wherein the recommended videos are obtained based on a correlation between the video search information and the large-scale videos marked with a plurality of tags.

16. The electronic device as claimed in claim 15, wherein the processor receives an activation message for a correlation map through the user interface, and displays the large-scale videos in the user interface based on at least one of the attributes in the large-scale videos according to the activation message.

17. The electronic device as claimed in claim 15, wherein the processor plays the large-scale videos in sequence according to the correlation between the video search information and the tags of the large-scale videos.

18. The electronic device as claimed in claim 16, wherein the user interface comprises:
a first object, configured to output an activation message associated with a default recommendation list of the recommended videos; wherein the user interface displays the default recommendation list in response to the first object being clicked;
a second object, configured to output the activation message of a video-time correlation map associated with the recommended videos; the user interface displays the video-time correlation map in response to the second object being clicked; and
a third object, configured to output the activation message of a video-position correlation map associated with the recommended videos; the user interface displays the video-position correlation map in response to the third object being clicked.

19. The electronic device as claimed in claim 15, wherein the processor is configured to:
detect changes in the number of recommended videos;
obtain a maximum field number when the recommended videos are displayed in the user interface;
determine a current field number based on the number of recommended videos and the maximum number of fields;
determine the number of at least one special adaptive video comprised in the recommended videos;
calculate a width percentage of the at least one special adaptive video; and
calculate a width percentage of a plurality of generic adaptive videos comprised in the recommended videos.

20. The electronic device as claimed in claim 18, wherein the user interface comprises:
a search field object, configured to allow users to enter the video search information.

21. A computer program product, executed on a smart camera, a back-end server, and a terminal device, wherein the back-end server is electrically coupled between the smart camera and the terminal device, comprising:
an event triggering module, enabling a processor of the smart camera to detect an event and output the large-scale videos according to the event;
a video annotation module, enabling the processor of the smart camera to tag the large-scale videos with a plurality of tags; wherein the tags comprise a plurality of attributes of at least one object in the large-scale videos;
an input module, enabling a processor of the back-end server to receive video search information from the terminal device;
an attribute comparison module, enabling the processor of the back-end server to compare a correlation between the video search information and the tags of the large-scale videos;
an output module, enabling the processor of the back-end server to correspondingly output a plurality of recommended videos to the terminal device according to the correlation; wherein the terminal device comprises a display;
a detection module, enabling a processor of the terminal device to detect a resolution of the display; and
an adaptive display module, enabling the processor of the terminal device to adaptively play the recommended videos in a user interface on the display according to the resolution.
